(19) United States
(12) Patent Application Publication
(10) Pub. No.: US 2011/0110201 A1
(43) Pub. Date: May 12, 2011

(54) PORTABLE OBJECT WITH DECORATIVE EFFECT

(75) Inventor: Maamar Boularas, Boudry (CH)

(73) Assignee: THE SWATCH GROUP MANAGEMENT SERVICES AG, Biel (CH)

(21) Appl. No.: 12/935,989

(22) PCT Filed: Apr. 1, 2009
(86) PCT No.: PCT/EP2009/053888

§ 371 Date: Dec. 27, 2010

(30) Foreign Application Priority Data
Apr. 1, 2008 (EP) 08153894.4

(51) Int. Cl. G04B 47/04

(52) U.S. Cl. 368/285

(57) ABSTRACT

The invention concerns a portable object (1). This portable object includes at least one transparent or semi-transparent decorative element (2) arranged and held on a support (6). The element takes the form and appearance of a precious stone. The portable object further includes a layer of luminescent material (10), arranged at least between one part of the support (6) and the decorative element (2) held on the support, to produce a visual effect through the element by reflection or refraction of the light passing therethrough.

This is a National Phase Application in the United States of International Patent Application No. PCT/EP2009/053888 filed Apr. 1, 2009, which claims priority on European Patent Application No. 08153894.4, filed Apr. 1, 2008. The entire disclosures of the above patent applications are hereby incorporated by reference.

The present invention concerns generally a portable object, which has a decorative effect. The object includes at least one transparent or semi-transparent decorative element arranged and held on a support. The element has the shape and appearance of a precious stone.

### BACKGROUND OF THE INVENTION

Portable objects such as watches are known from the prior art whose aesthetic appearance is improved by setting decorative elements therein.

Usually, these decorative elements are fixed to a support, generally a dome, which can be directly moulded onto the watchcase or it may be an added part in which the element is set to be later fixed to the watch. These decorative elements may be real precious stones but also elements such as strass, shiny plastic, glass or crystal.

A means of enhancing the aesthetic appearance of the assembly by increasing the brilliance of the decorative element, is also known from the prior art. When the elements are not real precious stones, this also creates an illusion of real stones. This increase in brilliance is achieved in the prior art by polishing the inner walls of the dome in which the decorative element is set, so as to reflect light passing through the decorative element and thereby increase the brilliance produced.

However, one of the problems that arises is that this brilliance is dependent upon the light passing through the decorative element. Thus, at nightfall or when the person wearing the watch is in a dark room, the quantity of light passing through the decorative element decreases considerably up to a value of zero, and thus no brilliance will be visible to the user, thus removing the aesthetic effect normally produced by the decorative elements.

### SUMMARY OF THE INVENTION

The invention concerns a portable object, which overcomes the aforementioned drawbacks of the prior art by proposing an arrangement with a decorative element that produces the same brilliance when the quantity of ambient light passing through the element becomes low or even zero.

The invention therefore concerns the aforecited portable object with a decorative effect, which includes a layer of luminescent material, arranged at least between one part of the support and the decorative element held on the support, to produce a visual effect through the element by reflection and refraction of the light passing therethrough, the decorative element including a pavilion, into which several facets are cut, and a crown that is also faceted and on which a table is mounted, the pavilion of the element being truncated, and which is characterized in that the surface of the truncated pavilion of the decorative element that is opposite the bottom of the support is at a distance of 0.25 mm from the layer of luminescent material.

Thus, in accordance with a first embodiment of the present invention, a portable object (1) is provided, wherein the portable object (1) includes: (a) at least one transparent or semi-transparent decorative element (2) arranged and held on a support (6), wherein the element takes the form and appearance of a precious stone; (b) a layer of luminescent material (10) that is arranged at least between one part of the support (6) and the decorative element (2) held on the support, to produce a visual effect through the element, by reflection and refraction of the light passing therethrough, wherein the decorative element includes a pavilion (3), in which several facets are cut and a crown (4), which is also faceted and on which a table (5) is mounted, wherein the pavilion of the element is truncated, characterized in that the surface (11) of the truncated pavilion of the decorative element (2) opposite the bottom of the support is at a distance of 0.25 mm from the layer of luminescent material (10).

Advantageous embodiments of this portable object form the subject of additional embodiments two through nine.

More specifically, in accordance with a second embodiment of the invention, the first embodiment is modified so that the lateral walls (7) of the support are also covered with the layer of luminescent material (10). In accordance with a third embodiment of the present invention, the first embodiment and the second embodiment are further modified so that the support (6) is a dome, the bottom (8) of which is flat and the lateral wall (7) is circular and cylindrical and can hold only one decorative element (2), and in that the layer of luminescent material (10) is of the phosphorescent type. In accordance with a fourth embodiment of the present invention, the first embodiment, the second embodiment, and the third embodiment are further modified so that the support (6) is a part that can be slid into a housing in the portable object, and fixed by securing means. In accordance with a fifth embodiment of the present invention, the fourth embodiment is further modified so that the support (6) is secured inside the housing thereof by bonding.

In accordance with a sixth embodiment of the present invention, the first embodiment, the second embodiment, the third embodiment, the fourth embodiment and the fifth embodiment are further modified so that the object takes the form of a watch that includes at least a watchcase, a dial and a time base. In accordance with a seventh embodiment of the present invention, the sixth embodiment is further modified so that the watch dial (1) acts as a support for one or more decorative elements. In accordance with an eighth embodiment of the present invention, the sixth embodiment is further modified so that the watch dial and/or the watchcase act as a support for one or several decorative elements (2). In accordance with a ninth embodiment of the present invention, the sixth embodiment, the seventh embodiment, and the eighth embodiment, are further modified so that several decorative elements (2) can be arranged and held in a single support.

One of the advantages of the present invention is that it provides a portable object with improved aesthetics in that the aesthetic appearance is visible both in daylight and also when the ambient lighting decreases. This feature is due to the layer of luminescent material.

Advantageously, the layer of luminescent material is located between each decorative element and the bottom of the holding support thus enabling light to be generated, in low ambient lighting, so as to illuminate the decorative elements such as precious stones or other strass. This then provides an additional aesthetic effect.

In addition to the aesthetic effect, another advantage of the present invention is that these decorative elements, whose aesthetic effect is perceived even in low levels of lighting, can be used as an indicator. Indeed, if the decorative elements are placed at key places on the watchcase, they can then act as a reference point for indicating the time. Thus association with a hand, which is also provided with luminescent material, enables the time to be displayed in a low lit medium whilst taking advantage of an aesthetic effect.

Another example could be to arrange the decorative elements so as to form a figure or sign that lights up once the lighting is low, such as a constellation, for example.

### BRIEF DESCRIPTION OF THE DRAWINGS

The objects, advantages and features of the portable object according to the present invention will appear more clearly in the following detailed description of at least one embodiment of the invention given by way of non-limiting example and illustrated by the annexed drawings, in which:

FIG. 1 shows schematically a portable object in the form of a watch dial according to the present invention,

FIG. 2 shows schematically a first variant of the decorative element according to the present invention,

FIG. 3 shows schematically a second variant of the decorative element according to a preferred embodiment of the present invention, and

FIG. 4 shows schematically a third variant of the decorative element according to the present invention.

### DETAILED DESCRIPTION OF THE INVENTION

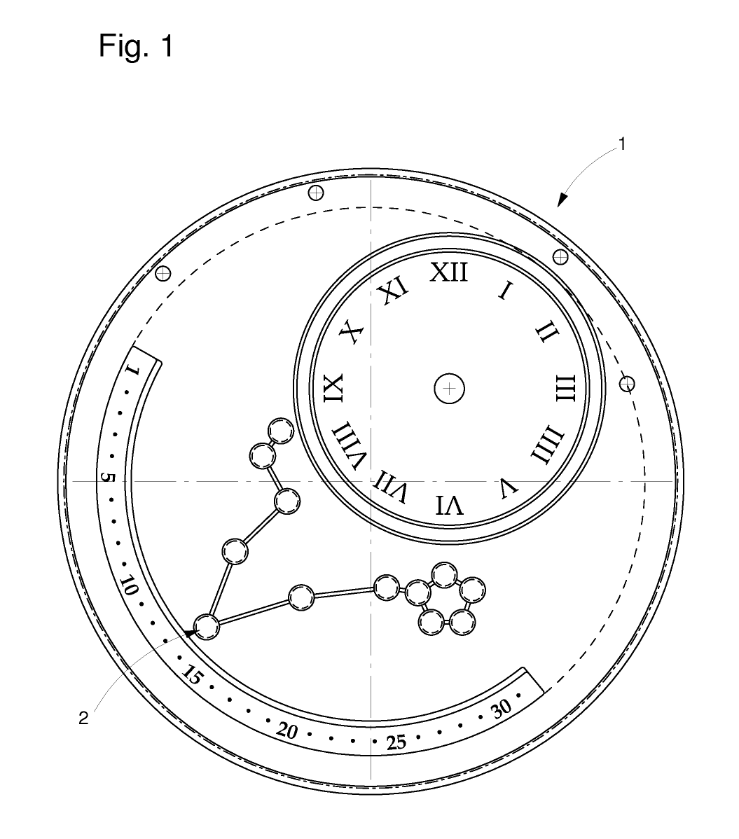

FIG. 1 shows a preferred embodiment of the portable object according to the present invention, i.e. in the form of a watch and more specifically a watch dial 1. It is clear that other embodiments can be envisaged such as jewellery: rings, necklaces, bracelets or even portable objects such as telephones or suchlike. The dial is fixed to the bottom plate of the watch and is used for the display. In fact, this part, which is the dial, can including markings indicating the hours, minutes and seconds, but also the days and so on. The dial may also include a certain number of apertures, through which the date or moon phase indications are indicated.

Dial 1 according to FIG. 1 has a main aperture for the watch hand arbours (not shown) to pass through. A series of decorative elements 2 can be seen on the dial, arranged to form an attractive pattern. In the example shown in FIG. 1, the series of decorative elements takes the form of a zodiac constellation, but it goes without saying that any other pattern may be made. Moreover, another embodiment may be to use these decorative elements 2 to indicate the hours or suchlike.

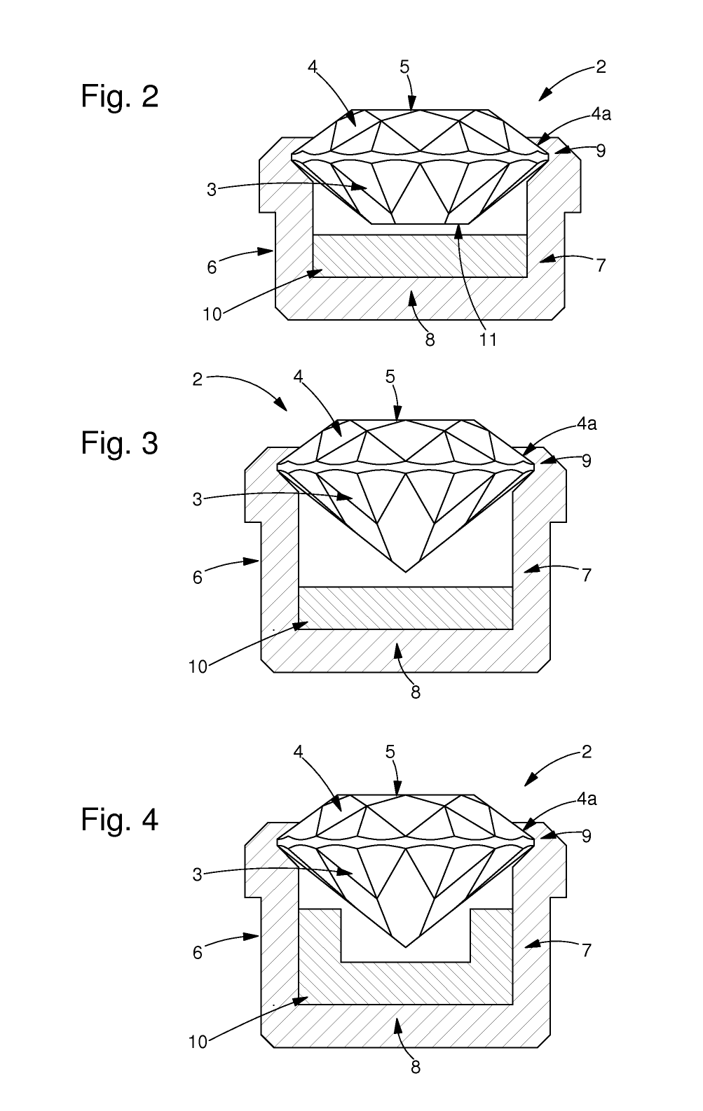

These decorative elements 2 are shown in detail in FIGS. 2, 3 and 4. Decorative elements 2 are generally made of transparent or semi-transparent material having a similar cut to diamonds or any other cut offering an interesting attractive appearance. The possible cuts of stone are brilliant or baguette or other types of cut with several facets. This decorative element thus includes a pavilion 3, into which several facets are cut, and a crown 4 which is also faceted and on which a table 5 is mounted. For purposes of economy, decorative element 2 may preferably be formed by a piece of glass, crystal, transparent plastic or strass. However, there is nothing to prevent the use of a brilliant.

This decorative element 2 is housed in a support 6, and then fixed so that it does not come out of the support. In a preferred embodiment, support 6 takes the form of a dome, whose bottom 8 is flat and lateral wall 7 is circular and cylindrical. The top edge 9 of wall 7 is turned down over the girdle 4a of decorative element 2. It therefore forms a setting for the element in dome 6, which thus holds it firmly in place. It is clear however that any possible form can be envisaged for support 6 and that supports 6 that can include several decorative elements 2 are also possible. Moreover, it will also be clear that any means can be envisaged for holding the decorative element 2 on support 6.

The way that the present invention solves the aforementioned problem is that dome 6 is arranged to include a layer of luminescent material 10. Indeed, a layer of luminescent material 10 is deposited in bottom 8 of the dome. Thus, the luminescent material can emit light, which will then pass through decorative element 2 and, by reflection and refraction, give it additional brilliance.

A layer of luminescent material 10 can also be deposited above or only on the internal surfaces of walls 7 of dome 6, as shown in FIG. 4, so as to increase the quantity of light that will pass through element 2 or simply to alter the diffusion of the emitted light.

In a preferred embodiment, the luminescent material is a phosphorescent material. Indeed, this type of material is very practical in that in daylight there is no need to artificially increase the brilliance of decorative element 2, since daylight is amply sufficient. However, when the ambient light decreases, daylight becomes insufficient to maintain the brilliance of the element 2. A phosphorescent material comes into its own here since the material can accumulate daylight when the ambient light is good and when it decreases, the phosphorescent material will emit light to make up for the decrease. This then maintains the brilliance of decorative element 2; thereby improving the aesthetic return thereof.

Still more preferentially, one can choose LUMINOVA® as phosphorescent material, which has the characteristic of emitting brighter light for a longer time, while being free of radioactive chemical components.

Dome 6 is formed such that an entire decorative element cut to take the appearance and form of a precious stone can enter the dome 6 as shown in FIG. 3. However, in order to save space, decorative element 2 can be truncated. In the case of a cut element such as a diamond, it would be the pavilion 3 of the element that was truncated. In this configuration, the surface 11 formed by truncating the element will be located at a certain distance from layer 10 of luminescent material. This configuration then allows better diffusion of the light emitted by the luminescent material and thus a reinforced visual effect compared to a configuration wherein truncated surface 11 of decorative element 2 is directly in contact with the layer of material 10. Preferably, it will be noted that a distance of I between 0 mm and 0.25 mm provides optimum visual effect.

The assembly comprising the dome on which decorative element 2 is set, is fixed to the dial by bonding the bottom of dome 6 to the bottom of the housing. To prevent internal stress within the dial, the diameter of dome 6 can be slightly less than that of the housing. However, dome 6, in which decorative element 1 is set, may also be directly integrated into the dial during manufacture thereof, thereby preventing problems of stress between the various parts. Of course, the above description concerned the case where decorative elements 2 are situated on a watch dial, but it is also possible for elements 2 to be integrated in the watchcase and hence no significant change need be made.

It will be clear that various alterations and/or improvements and/or combinations evident to those skilled in the art can be made to the various embodiments of the invention set out above without departing from the scope of the invention defined by the annexed claims.

1-9. (canceled)

10. A portable object including at least one transparent or semi-transparent decorative element arranged and held on a support, said element taking the form and appearance of a precious stone, a layer of luminescent material being arranged at least between one part of the support and the decorative element held on the support, to produce a visual effect through the element, by reflection and refraction of the light passing therethrough, said decorative element including a pavilion, in which several facets are cut and a crown, which is also faceted and on which a table is mounted, the pavilion of said element being truncated, wherein the surface of the truncated pavilion of the decorative element opposite the bottom of the support is at a distance of 0.25 mm from the layer of luminescent material.

11. The portable object according to claim 10, wherein the lateral walls of said support are also covered with the layer of luminescent material.

12. The portable object according to claim 10, wherein that the support is a dome, the bottom of which is flat and the lateral wall is circular and cylindrical and can hold only one decorative element and wherein the layer of luminescent material is of the phosphorescent type.

13. The portable object according to claim 10, wherein the support is a part that can be slid into a housing in said portable object, and fixed by securing means.

14. The portable object according to claim 13, wherein the support is secured inside the housing thereof by bonding.

15. The portable object according to claim 10, wherein said object takes the form of a watch including at least a watchcase, a dial and a time base.

16. The portable object according to claim 15, wherein the watch dial acts as a support for one or more decorative elements.

17. The portable object according to claim 15, wherein the watch dial and/or the watchcase act as a support for one or several decorative elements.

18. (NEW The portable object according to claim 15, wherein several decorative elements can be arranged and held in a single support.

19. The portable object according to claim 11, wherein that the support is a dome, the bottom of which is flat and the lateral wall is circular and cylindrical and can hold only one decorative element and wherein the layer of luminescent material is of the phosphorescent type.

20. The portable object according to claim 11, wherein the support is a part that can be slid into a housing in said portable object, and fixed by securing means.

21. The portable object according to claim 16, wherein several decorative elements can be arranged and held in a single support.

22. The portable object according to claim 17, wherein several decorative elements can be arranged and held in a single support.
